(19) United States
(12) Patent Application Publication
(10) Pub. No.: US 2002/0095664 A1
(43) Pub. Date: Jul. 18, 2002

(54) Pre-interpretation and execution method for Java computer program language

(76) Inventor: Wangtun Chou, Taipei Hsien (TW)

Correspondence Address: BACON & THOMAS, PLLC, 625 Slaters Lane - 4th Floor, Alexandria, VA, 22314-1176, US

(21) Appl. No.: 09/761,681

(22) Filed: Jan. 18, 2001

(51) Int. Cl. G06F 9/45

(52) U.S. Cl. 717/139; 717/148; 717/118

(57) ABSTRACT

A pre-interpretation and execution method of Java computer program language is disclosed. In an embedded type device, a pointer lookup table is built for mapping a running code of each bytecode to a respective subroutine. When the embedded type device downloads a Java program from a network, the received running code is converted into the pointer data of the respective subroutine entrance point according to the pointer lookup table. The operator is converted from a network format into a machine format. An adjusting step is performed for maintaining a correction of corresponding addressing. The converted result is stored into the embedded type device. A pointer data representing a respective subroutine and the operator of machine format are read sequentially for being executed, so as to complete an execution of the Java computer program language.

### BACKGROUND OF THE INVENTION

1. Field of the Invention

The present invention relates to a pre-interpretation and execution method for Java computer program language, and especially to a method applied to run a Java computer program language in an operation system of an embedded type device connected to a network,

2. Description of Related Art

With the wide applications of computer networks, the Java computer program language developed by SUN Co. becomes more and more important. Since the Java computer program language has the function of running across different platforms, the Java program can be used in various computer environment so that the network user may download program from the network server to the user's computer to reduce the burden of the network server.

Since the Java computer program language must has the function of running across different platforms, the execution code acquired through the compiling of the Java computer program language is formed based on the basic unit of bytecode. The bytecode is correspondent to the “machine language” of a Java virtual machine. The program is executed through a step-by-step interpretation. Conventionally, the most frequently used method is that after the whole program in a form of bytecode is downloaded from a network server, the program code assembled by bytecodes is interpreted each time as the program is executed, including the steps of re-converting the operator in the program (from a network format to a machine format). However, this will cause the low efficiency of running a program, while it has an advantage of only occupying a small volume.

In order to eliminate such a drawback, a just-in-time (JIT) compile method is developed. With such a JIT method, when the Java computer program language with a bytecode code is downloaded from a network server to the user computer at a low transmission speed, the waiting time is utilized to immediately compile the received bytecodes into native code for being stored. As the whole program is compiled for being executed, the native codes can be run directly. Therefore, the running efficiency is improved. Whereas for using this method, a preferred just-in-time compiler must be equipped in the user's computer, and moreover, the compiled native codes occupies a larger memory space. Thus, the disadvantage is that the requirement for the user's hardware is high, so that it is not beneficial for embedded type devices with limited hardware devices or memory, such as TV with a function of browser, a telephone machine, an electronic dictionary, and a personal digital assistant. Therefore, it is desirable to provide an improved method to mitigate and/or obviate the aforementioned problems.

### SUMMARY OF THE INVENTION

An object of the present invention is to provide a pre-interpretation and execution method of Java computer program language for running a Java computer program language in an operation system of an embedded type device connected to a network. The method comprises the steps of: (a) establishing a pointer lookup table in an embedded type device for mapping a running code of each bytecode to a respective subroutine; (b) when the embedded type device downloads a Java program from a network, converting received running code for each bytecode into a pointer data of a respective subroutine entrance point according to the pointer lookup table, and converting operators from a network format into a machine format; then, after an adjusting step for maintaining a correction of corresponding addressing is performed, storing converted result into the embedded type device; and (c) reading a pointer data representing a respective subroutine and the operator of machine format sequentially for being executed, so as to complete an execution of the Java program in the operation system of the embedded type device.

Another object of the present invention is to provide a pre-interpretation and execution method of a computer program language having a function of running across different platforms for being applied to an operation system of an embedded type device connected to a network. The method comprises the steps of: (a) establishing a pointer lookup table in an embedded type device for mapping a running code of each bytecode to a respective subroutine; (b) when the embedded type device downloads a computer program language having a function of running across different platforms from a network, converting received running code for each bytecode into a pointer data of a respective subroutine entrance point according to the pointer lookup table, and converting operators from a network format into a machine format; then, after an adjusting step for maintaining a correction of corresponding addressing is performed, storing converted result into the embedded type device; and (c) reading a pointer data representing a respective subroutine and the operator of machine format sequentially for being executed, so as to complete an execution of the computer program language having a function of running across different platforms in the operation system of the embedded type device.

Other objects, advantages, and novel features of the invention will become more apparent from the following detailed description when taken in conjunction with the accompanying drawings.

### DETAILED DESCRIPTION OF THE PREFERRED EMBODIMENT

In order to increase the running speed of the conventional step-by-step interpretation way, and save hardware devices required in the customer end in the just-in-time compile so as to be suitable for the embedded type devices (such as TV with a function of browser, a telephone machine, an electronic dictionary, a hand hold personal digital assistant) that has limited hardware device and memory, a preferred embodiment of the pre-interpretation and execution method for Java computer program language in accordance with the present invention is executed based on the following steps:.

(a) Establish a pointer lookup table in the embedded type device for mapping a running code of each bytecode to a respective subroutine, for example:

0×00 is correspondent to nop( ),

0×01 is correspondent to aconst_null( ) ........

0×02 is correspondent to iaload ( ), etc.

The pointer look up table is stored in a memory.

(b) When the embedded type device downloads a Java program from a network, the received running code for each bytecode is pre-converted into pointer data of the respective subroutine entrance point according to the correspondent relation of the pointer lookup table, and the operator is converted from a network format into a machine format. Then the converted result is stored sequentially. However, in order to maintain the addressing relation after the network format is converted into the machine format, the void generated by converting the operator from network format into machine format of the operator is compensated by an NOP subroutine. For example, if more than two operators are incorporated into one operator, the NOP subroutine must compensate bytes to the left space for retaining the correction of the relative addressing.

(c) The pointer data representing a respective subroutine and the operator of the machine format are read sequentially for being executed. In execution, the read pointer data is used as an instruction pointer for directing to a calling subroutine. Then, the process directly jumps into the entrance point of the subroutine pointed by the instruction pointer. When an operator is read, the instruction pointer is moved backwards through a memory unit, and then an operator is acquired through the instruction pointer. Besides, when it is desired to perform the next instruction, a variable (IP) is moved backwards through a memory unit, and then according to the read pointer data, the process jumps into the subroutine entrance point pointed by the instruction pointer.

The pre-interpretation Java virtual machine implemented by the method of the present invention has the following technical features.

1. The adapted pre-interpretation way has an effect close to the native code, while the load of a just-in-time compile is not required in the hardware of the customer end.

2. The memory space occupied by the interpretation result is only enlarged finitely (a 16-bit machine occupies a space of twice of the original bytecode, and a 32-bit machine occupies a space of four times of the original bytecode). The saved memory space of the just-in-time compile (JIT) is predictable.

3. The void as the operator is converted from a network format into a machine format is compensated by NOP, and thus the complexity of the branch command is simplified.

Although the present invention has been explained in relation to its preferred embodiment, it is to be understood that many other possible modifications and variations can be made without departing from the spirit and scope of the invention as hereinafter claimed.

What is claimed is:

1. A pre-interpretation and execution method of Java computer program language for running a Java computer program language in an operation system of an embedded type device connected to a network, comprising the steps of:
(a) establishing a pointer lookup table in an embedded type device for mapping a running code of each bytecode to a respective subroutine;
(b) when the embedded type device downloads a Java program from a network, converting received running code for each bytecode into a pointer data of a respective subroutine entrance point according to the pointer lookup table, and converting operators from a network format into a machine format; then, after an adjusting step for maintaining a correction of corresponding addressing is performed, storing converted result into the embedded type device; and
(c) reading a pointer data representing a respective subroutine and the operator of machine format sequentially for being executed, so as to complete an execution of the Java program in the operation system of the embedded type device.

2. The pre-interpretation and execution method of Java computer program language as claimed in claim 1, wherein the adjusting step for maintaining the correction of corresponding addressing comprises a step of, after converting the network format into machine format, compensating bytes to the left void through an NOP subroutine.

3. The pre-interpretation and execution method of Java computer program language as claimed in claim 1, wherein in step (c) for reading a pointer data representing a respective subroutine and the operator of machine format sequentially for being executed, the read pointer data is used as an instruction pointer for directing to a calling subroutine, and then the process directly jumps into an entrance point of the subroutine pointed by the instruction pointer.

4. The pre-interpretation and execution method of Java computer program language as claimed in claim 1, wherein in step (c) for reading a pointer data representing a respective subroutine and the operator of machine format sequentially for being executed, when an operator is read, the instruction pointer is moved backwards through a memory unit, and then the operator is acquired through the instruction pointer.

5. The pre-interpretation and execution method of Java computer program language as claimed in claim 1, wherein in step (c) for reading a pointer data representing a respective subroutine and the operator of machine format sequentially for being executed, when it is desired to perform a next instruction, a variable is moved backwards through a memory unit, and then according to the read pointer data, the process jumps into the subroutine entrance point pointed by the instruction pointer.

6. A pre-interpretation and execution method of a computer program language having a function of running across different platforms for being applied to an operation system of an embedded type device connected to a network, comprising the steps of:
(a) establishing a pointer lookup table in an embedded type device for mapping a running code of each bytecode to a respective subroutine;
(b) when the embedded type device downloads a computer program language having a function of running across different platforms from a network, converting received running code for each bytecode into a pointer data of a respective subroutine entrance point according to the pointer lookup table, and converting operators from a network format into a machine format; then, after an adjusting step for maintaining a correction of corresponding addressing is preformed, storing converted result into the embedded type device; and
(c) reading a pointer data representing a respective subroutine and the operator of machine format sequentially for being executed, so as to complete an execution of the computer program language having a function of running across different platforms in the operation system of the embedded type device.

7. The pre-interpretation and running method of a computer program language having a function of running across different platforms as claimed in claim 6, wherein the computer program language is a Java computer program language.

8. The pre-interpretation and execution method of a computer program language having a function of running across different platforms as claimed in claim 7, wherein the adjusting step for maintaining the correction of corresponding addressing comprises a step of, after converting the network format into machine format, compensating bytes to the left void through an NOP subroutine.

9. The pre-interpretation and execution method of a computer program language having a function of running across different platforms as claimed in claim 7, wherein in step (c) for reading a pointer data representing a respective subroutine and the operator of machine format sequentially for being executed, the read pointer data is used as an instruction pointer for directing to a calling subroutine, and then the process directly jumps into an entrance point of the subroutine pointed by the instruction pointer.

10. The pre-interpretation and execution method of a computer program language having a function of running across different platforms as claimed in claim 9, wherein in step (c) for reading a pointer data representing a respective subroutine and the operator of machine format sequentially for being executed, when an operator is read, the instruction pointer is moved backwards through a memory unit, and then the operator is acquired through the instruction pointer.

11. The pre-interpretation and execution method of a computer program language having a function of running across different platforms as claimed in claim 9, wherein in step (c) for reading a pointer data representing a respective subroutine and the operator of machine format sequentially for being executed, when it is desired to perform a next instruction, a variable is moved backwards through a memory unit, and then according to the read pointer data, the process jumps into the subroutine entrance point pointed by the instruction pointer.
